(19) United States
(12) Patent Application Publication
(10) Pub. No.: US 2014/0334879 A1
(43) Pub. Date: Nov. 13, 2014

(54) METHOD OF GRIPPING A PIPELINE

(71) Applicant: Cornelis Van Zandwijk, Leiden (NL)

(72) Inventor: Cornelis Van Zandwijk, Leiden (NL)

(73) Assignee: HEEREMA MARINE CONTRACTORS NEDERLAND SE, Leiden (NL)

(21) Appl. No.: 14/343,361

(22) PCT Filed: Sep. 10, 2012
(86) PCT No.: PCT/NL2012/050633

§ 371 Date: Jul. 2, 2014

Related U.S. Application Data
(60) Provisional application No. 61/532,855, filed on Sep. 9, 2011.

(30) Foreign Application Priority Data
Sep. 9, 2011 (NL) 2007386

(51) Int. Cl. F16L 9/04; F16L 1/19; F16L 1/20; B21D 51/10; B21D 51/16

(52) U.S. Cl. CPC F16L 9/047; B21D 51/10; B21D 51/16; F16L 1/207; F16L 1/19; F16L 1/205
USPC 405/166; 138/103; 138/142; 29/428; 29/506; 405/184.4

(57) ABSTRACT

The present invention relates to a pipe section (10), constructed to be joined end-to-end to a same pipe section in order to form a pipeline which is laid from a pipeline laying vessel, the pipe section having a pipe has a greater wall thickness than the wall thickness of a main part of the pipe wall (15), the pipe section comprising a thickened gripping zone (20) which section, wherein the thickened gripping zone has a length (22) and a wall thickness which are constructed and arranged to allow a shear clamp (45) having protrusions (48) to grip the thickened gripping zone in order to suspend the pipeline from the pipeline laying vessel via the thickened gripping zone.

### FIELD OF THE INVENTION

The present invention relates to an improved pipe section for a pipeline laying operation. The invention further relates to an improved pipe clamp for a pipeline laying device in a pipeline laying vessel, the pipe clamp being configured to grip the pipe section. The invention further relates to a pipeline laying vessel comprising the improved clamp and to a method of laying a pipeline using the improved pipe section and the improved clamp.

### DISCUSSION OF THE PRIOR ART

Hydrocarbons such as oil and gas are often found in marine environments, i.e. under a seabed. Typically, when a new well is prepared for production, one or more pipelines are laid on the seabed, the pipeline extending between the surface installation of a well and another location. Generally, a pipeline laying vessel is used for laying such a pipeline. Pipelines may also be laid on the seabed for other purposes.

Different kinds of pipeline laying vessels exist. “J-lay” and “S-lay’ methods are known methods of laying a pipeline and multiple vessels have been built and are operated for each of these methods. The words “S-lay” and “J-lay” refer to the form of the pipeline which is suspended from the vessel and extends to the seabed.

Both S-lay and J-lay can be performed with different methods for paying out the pipeline from the pipeline laying vessel. One method is often referred to as “stove piping”. In this method, each time a pipe section is attached to the free end of the pipeline which is suspended from the vessel. By doing this repeatedly, the complete pipeline is formed.

Another method is reeling, wherein a relatively large length of pipe is spooled from a reel and launched from the pipeline laying vessel. These lengths of pipe are much longer than the lengths of pipe which are used in J-lay.

During the pipeline laying operation, the free end of the pipeline needs to be held securely by the vessel, or else it will drop all the way from the vessel to the seabed. This may result in a complete loss of the pipeline. Substantial forces are required to hold the pipeline, because the length of pipeline which is suspended from the vessel can be significant, for instance 3000 meter or even more. The length of pipeline required to be supported tends to increase over time, because the search for hydrocarbons leads to ever deeper locations at sea.

Different clamps exist for holding the pipeline and/or for paying out the pipeline from the pipeline laying vessel. Two general types of clamps exist, friction clamps and collar clamps.

A friction clamp works on friction with the pipe wall. The friction clamp comprises wedges or pads which are connected to hydraulic clamps. The wedges or pads press against the pipe wall, or any coating that may be applied onto the pipe wall. The compression force of the wedges or pads results in the possibility of exerting a friction force in the direction of the pipe axis from the wedges or pads to the pipe wall or the coating.

A friction clamp may have a function of only holding the pipeline, or may have a further function of paying out the pipeline. In order to pay out the pipeline, the friction clamp can be a movable clamp, which is mounted on a travelling block. Another type of friction clamp is a tensioner, which comprises endless tracks which are constructed to rotate and lower a pipeline on friction. Generally, two, three or four tracks are positioned around the circumference of the pipe.

A collar clamp is constructed to engage a collar (or flange) on the pipe. The collar clamp comprises a shoulder which is constructed to engage the underside of the collar on the pipe. The collar is formed in such a way that the axial forces which are exerted on the underside of the collar are guided through the material which forms the collar and into the pipe wall without damage to the pipe.

A collar clamp may have a function of only holding the pipeline, or may have a further function of paying out the pipeline. In order to pay out the pipeline, the collar clamp can be a movable clamp, which is mounted on a travelling block.

With a collar clamp, the risk of the pipe falling from the pipeline laying vessel may be smaller than for a friction clamp. This is an advantage. However, the labour and costs required to manufacture collars and secure them to individual pipe sections are large, and therefore this option can be disadvantageous. Other advantages and disadvantages of the use of friction versus the use of collars also exist.

### SUMMARY OF THE INVENTION

The present invention provides a pipe section which is constructed to be joined end-to-end to a same pipe section in order to form a pipeline which is laid from a pipeline laying vessel, the pipe section comprising a thickened gripping zone which has a greater wall thickness than the wall thickness of a main part of the pipe section, wherein the thickened gripping zone is constructed and arranged to allow lasting indentations to be made in the thickened gripping zone by a pipe clamp having protrusions which—in use—are pressed into the thickened gripping zone, in order to transfer an axial force to the pipeline for suspending the pipeline from the pipeline laying vessel to the seabed.

In an embodiment, the thickened gripping zone has a wall thickness which lies between 1.1 and 2 times the wall thickness of a main part of the pipe section, in particular between 1.2 and 1.6 times the wall thickness of the main part of the pipe section.

In an embodiment, the thickened gripping zone has a length which lies between 0.5 and 2 times the outer diameter of the main part of the pipe section, in particular between 0.8 and 1.5 times the outer diameter of the main part of the pipe section.

In an embodiment, the thickened gripping zone has a length which lies between 200 and 700 mm, in particular between 300 and 500 mm.

In an embodiment, a length of the thickened gripping zone is configured to allow the pipe clamp with protrusions to exert an axial suspension force onto the pipeline which results from a weight of at least 2000 meter of suspended, submerged pipeline.

In an embodiment, the thickened gripping zone is composed of multiple subzones which are arranged about the circumference of the pipe section and which are separated from one another by grooves or interspacings, at which grooves or interspacings the pipe section has a smaller wall thickness than a wall thickness of the gripping zone.

In an embodiment, the thickened gripping zone has a width which is defined as a radial distance over which the thickened gripping zone protrudes from the pipe wall of the main part, and the length of the thickened gripping zone is between 20 and 150 times the width of the thickened gripping zone.

In an embodiment, the width of the thickened gripping zone is 2-20 mm, in particular 5-15 mm.

In an embodiment, the thickened gripping zone is formed by a substantially annular metal tube which is welded to the outer surface of a pipe element and which surrounds the pipe element.

In an embodiment, the pipe element is manufactured from steel and the weld-on metal tube is manufactured from a corrosion resistant alloy.

In an embodiment, the pipe section comprises at least two thickened gripping zones which are spaced apart over a distance along the length of the pipe section.

The present invention further relates to a pipe clamp constructed to be mounted on a pipeline laying vessel and configured to grip a pipeline composed of pipe sections according to the invention during a pipeline laying operation, the pipe clamp comprising a plurality of protrusions which are constructed to be pressed into a thickened gripping zone of an upper end of the pipeline and to make lasting indentations in the thickened gripping zone when the pipeline is gripped by the pipe clamp and to exert an upward force on the pipeline via the protrusions.

In an embodiment, the pipe clamp comprise of pads which are movable between a clamping position and a released position, wherein the protrusions protrude from the pads, wherein the pads have a total height which lies between 0.5 and 2 times a diameter which is enclosed by the pads when the pads are positioned in the clamping position, in particular between 0.8 and 1.5 times the diameter which is enclosed by the pads when the pads are positioned in the clamping position.

In an embodiment of the pipe clamp, the pads are constructed to grip the pipe section over a length of between 200-700 mm, in particular 300-500 mm.

In an embodiment of the pipe clamp, the pads comprise a plurality of protrusions which protrude from the surface of the pads over a radial distance of between 2-10 mm, in particular between 3-7 mm.

In an embodiment of the pipe clamp, the protrusions protrude from the surface of the pads over a radial distance of between 0.005 and 0.03 times the total height of the friction pads.

The present invention further relates to a combination of a pipe clamp and a pipe section, wherein the protrusions protrude over a radial distance from a surface of the pads, wherein said radial distance lies between 0.1 and 0.5 times the thickness of the pipe wall of the main part of the pipe section.

The present invention further relates to a pipeline laying vessel comprising the pipe clamp according to the invention.

In an embodiment of the pipeline laying vessel, the pipeline laying vessel comprises a fixed clamp which is a regular friction clamp, and a travelling clamp which is clamp according to the current invention.

The present invention further relates to a method of laying a pipeline from a pipeline laying vessel, the method comprising:
providing a plurality of pipe sections according to the invention,
providing a pipeline laying vessel comprising a pipe clamp according to the invention,
suspending said pipeline from the pipeline laying vessel by pressing the protrusions of the pipe clamp into the thickened gripping zone, making lasting indentations in the thickened gripping zone, while transferring an axial force to the pipeline via the protrusions.

In an embodiment of the method, said pipe clamp is a movable clamp, and wherein the pipeline laying vessel comprises a fixed clamp which is a regular friction clamp, the method performing alternating steps of:
lowering the pipeline with the movable clamp by pressing the protrusions into the thickened gripping zone and transferring an axial force to the pipeline, while moving the movable clamp downward, and
holding the pipeline with the fixed regular friction clamp by gripping the pipeline at a different section of the pipeline than the thickened gripping zone with the fixed regular friction clamp.

The present invention further relates to a method of manufacturing a pipe section according to the invention which is to be laid with the method according to the invention, the method comprising the steps of:
a. providing a pipe element without a thickened gripping zone and welding a short pipe comprising a thickened gripping zone in the shape of a collar to a distal end of the pipe element, or
b. providing a pipe element without a thickened gripping zone and locally increasing the wall thickness by depositing weld metal onto the outer pipe wall, and/or
c. providing a pipe element without a thickened gripping zone and welding a metal tube to the outer surface of the pipe element, the metal tube forming the thickened gripping zone, and/or
d. hitting one end face of a pipe element very hard with a tool, thereby deforming an upper end of the pipe element to such an extent that the pipe wall of the upper end obtains a greater thickness and becomes the thickened gripping zone by virtue of its greater wall thickness, and/or
e. providing a pipe element having a wall thickness which corresponds to the intended wall thickness of the thickened gripping zone and removing excessive material of the main section of the pipe element, and/or
f. providing a metal tube having a slightly smaller inner diameter than the outer diameter of a pipe element, and cooling the pipe section relative to the metal tube or heating the metal tube relative to the pipe element, so that due to thermal expansion the inner diameter of the metal tube becomes slightly greater than the outer diameter of the pipe element, sliding said metal tube over the pipe element into a desired position, cooling the metal tube relative to the pipe element in order to obtain the same temperature as the pipe element so that the metal tube becomes secured to the pipe element and forms the thickened gripping zone.

The pipe sections will generally be manufactured on shore, prior to the loading of the pipe sections on the pipelaying vessel. However, it is also possible that the pipe sections are manufactured on board the vessel, prior to the loading of the pipe sections in the pipelay installation of the vessel, e.g. the J-lay system.

In an embodiment of the method of manufacturing a pipe section, the method comprises the steps of connecting at least two pipes with one another, a main part and a short thicker pipe member.

In an embodiment of the method of manufacturing a pipe section, the method comprises:
a. connecting three pipes with one another, a main part, a short thicker pipe member and short normal pipe member, wherein the short thicker pipe member is arranged between the main part and the short normal pipe member and wherein the short thicker pipe member has a greater outer diameter than the main part and the short normal pipe member, or
b. connecting four pipes with one another in an arrangement having the following sequence, a main part, a short thicker pipe member, a short normal pipe member and another short thicker pipe member, or
c. connecting five pipes with one another in an arrangement having the following sequence, a main part, a short thicker pipe member, a short normal pipe member, another short thicker pipe member and another short normal pipe member.
   These alternative methods result in a pipe section according to the invention.

### BRIEF DESCRIPTION OF THE FIGURES

In the following, the aspects, features and advantages of the present invention will be elucidated further by reference to the annexed figures illustrating exemplary embodiments. In the figures, the same parts or parts having the same function have been identified with the same reference numeral.

FIG. 1 shows a sectional view of an upper end of a pipe section according to the invention with the relative dimensions.

FIG. 2 shows a sectional view of an upper end of a pipe section according to one embodiment of the invention.

FIG. 3 shows a sectional view of an upper end of a pipe section according to another embodiment of the invention.

FIG. 4A shows a sectional view of an upper end of a pipe section according to another embodiment gripped by a clamp having protrusions.

FIG. 4B shows a detailed sectional view of the thickened gripping zone of the pipe section of the invention being gripped by a clamp having protrusions.

FIG. 4C shows a sectional view in more detail of a protrusion.

FIG. 5 shows a diagram of the occurring stresses in the pipe and thickened gripping zone.

FIG. 6A shows a same embodiment as FIG. 1.

FIG. 6B shows a sectional view of a part of a pipe section according to another embodiment of the invention.

FIG. 7A shows a same embodiment as FIG. 2.

FIG. 7B shows a sectional view of a part of a pipe section according to another embodiment of the invention.

FIG. 8 shows a diagrammatic top view of a clamp according to the invention.

FIG. 9 shows a diagrammatic side view of a J-lay vessel.

FIG. 10 shows an orthogonal view of another embodiment of a pipe section according to the invention.

FIG. 11 shows a sectional view of a part of a pipe section according to a further embodiment of the invention.

FIG. 12 shows a sectional view of a part of a pipe section according to a further embodiment of the invention.

### DETAILED DESCRIPTION OF THE INVENTION

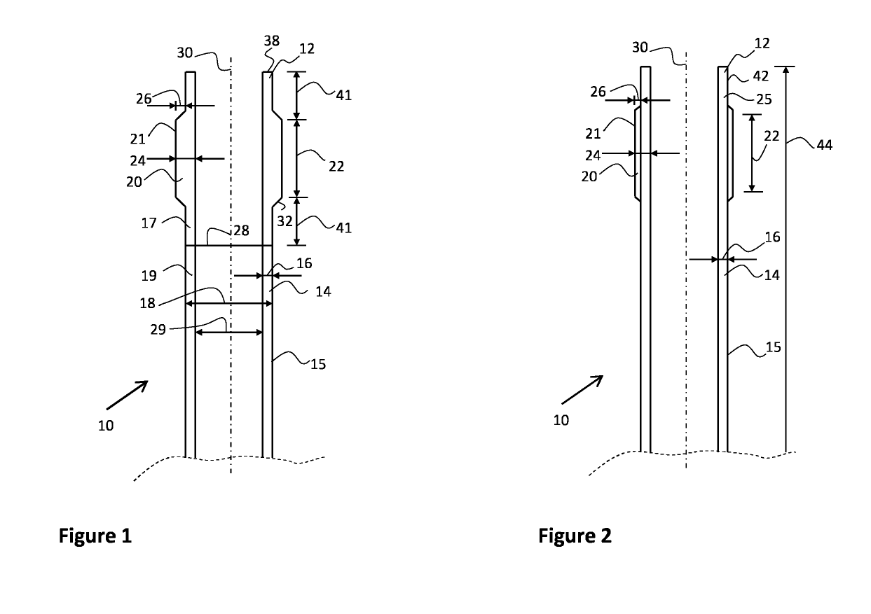

Turning to FIG. 1, an upper part 12 of a pipe section 10 according to the invention is shown. Pipe sections 10 are used in pipelay operations, in particular in a J-lay operation. The pipe section 10 is manufactured from steel. Pipelines are currently laid in water depths exceeding 3000 meter. This requires pipe sections of high quality, because the total force which is exerted by the pipe clamp on the pipeline in order to hold a suspended pipeline of 3000 meter is very high. Likewise, the pipe clamp itself should also be of high quality. The pipe section 10 is constructed and arranged for being joined by butt-welding to a same pipe section 10 in order to form a pipeline which is laid from a pipeline laying vessel.

The pipe section has a main part 14, of which only a small portion is shown. The pipe section 10 has a pipe wall 15. The pipe wall 15 has a wall thickness 16 which is uniform over the main part 14. The main part 14 of the pipe section has an outer diameter 18 and an inner diameter 29.

The pipe section 10 is circular and has a pipe axis 30. The pipe section 10 comprises a thickened gripping zone 20. The thickened gripping zone 20 has a length 22 and a wall thickness 24. The thickened gripping zone 20 has an outer surface 21 which is oriented radially. The outer surface 21 extends parallel to the pipe axis 30. The outer surface 21 of the thickened gripping zone 20 is smooth, i.e. free of any protrusions. The thickened gripping zone 20 has a width 26, which is defined as the radial distance over which the thickened gripping zone 20 protrudes from the pipe wall 15 of the main part 14. The thickened gripping zone width 26 is equal to the wall thickness 24 of the thickened gripping zone 20 minus the wall thickness 16 of the main part 14.

The width 26 of the thickened gripping zone (and the wall thickness 24 of the thickened gripping zone 20) is uniform over the length of the thickened gripping zone 20. The thickened gripping zone 20 is not tapered but extends parallel with the pipe wall 15 of the main part 14 of the pipe section 10. The pipe section 10 does not comprise thread on the outside or the inside.

The length 22 of the thickened gripping zone 20 is sufficient to allow a clamp 45 with protrusions 48 to exert a suspension force onto the pipeline of at least 600 metric tons. In the axial direction, a plurality of protrusions 48 are inserted into the thickened gripping zone 20.

The transition 32 between the thickened gripping zone 20 and the pipe wall 15 of the main part 14 is tapered. The transition 32 tapers at an angle of approximately 45 degrees to the pipe axis 30. The transition 32 is too small and extends at a too large angle to allow a sufficient force to be transferred to the pipe section 10 by a collar clamp which would engage the lower transition 32. Therefore, the transition 32 is not suitable to be used as a collar with a collar clamp under normal pipelay conditions, i.e. at water depths exceeding 100 meter. The pipe section 10 has a length between 10 meters and 100 meters.

The thickened gripping zone 20 has a wall thickness 24 which lies between 1.2 and 3 times the wall thickness 16 of the main part 14 of the pipe section 10, in particular between 1.4 and 1.5 times the wall thickness 16 of the main part 14 of the pipe section 10.

The thickened gripping zone 20 has a length 22 in the direction of the pipe axis 30 which lies between 0.7 and 3 times the outer diameter 18 of the main part 14 of the pipe section 10. In particular, the length may lie between 0.8 and 1.5 times the outer diameter 18 of the main part 14 of the pipe section 10.

It was found that a thickened gripping zone with a length which lies between 200 and 500 mm, in particular between 300 and 400 mm, is in particular suitable for being gripped by a pipe clamp having protrusions. The length of the thickened gripping zone is sufficient to allow the pipe clamp with protrusions to exert a suspension force onto the pipeline which results from a weight of at least 2000 meter of pipeline which is suspended from a pipeline laying vessel. Typically, the total suspension force may be between 600 and 2000 metric tons.

The thickened gripping zone 20 is generally provided near one end of the pipe section 10, i.e. at a distance 41 of between 100-300 mm from the end 38 of the pipe section 10. However, depending on the method of manufacturing of the thickened gripping zone 20, the thickened gripping zone may be provided at another location along the pipe section, for instance approximately half way or near an end which in use is the bottom end of the pipe section 10.

The length 22 of the thickened gripping zone is between 10 and 150 times the width 26 of the thickened gripping zone 20. The width 26 is 2-20 mm, in particular 5-15 mm. In the embodiment of FIG. 1, the thickened gripping zone 20 is an integral part of a top part 17 of the pipe section 10. The top part 17 is welded at weld 28 to a lower part 19 of the pipe section 10. The lower part 19 may be manufactured from line pipe material while the top part 17 is manufactured from forged steel. The top part 17 may have a length of about 700-800 mm.

In an embodiment, the thickened gripping zone 20 extends all the way to the end 38 of the pipe section 10, i.e. the distance 41 is zero. This embodiment may be manufactured by providing a separate main part 14 and a separate top part 17 which forms the thickened gripping zone 20 and connecting these two pipes to one another. The top part 17 has an inner diameter 29 which is equal to the inner diameter 29 of the main part 14 and an outer diameter which is greater than the outer diameter of the main part 14.

Turning to FIG. 2, the thickened gripping zone 20 comprises an extra layer of material which is attached to an outer surface 42 of a pipe element 25. The pipe element 25 has a uniform wall thickness along its length. The extra layer of material is not integral with the pipe element 25. The words “thickened gripping zone 20” refer to the combination of the extra layer of material and the region of the pipe element 25 to which the extra layer of material is attached. The extra layer of material is formed by a substantially annular metal tube 40 which is welded to the outer surface 42 of the pipe element 25 and which surrounds the pipe element 25. In this embodiment, the pipe section 10 is provided in its full final length 44 prior to the welding of the tube 40 around the pipe element 25. The tube 40 may be manufactured from a corrosion resistant alloy (CRA). This obviates the need for a later coating step.

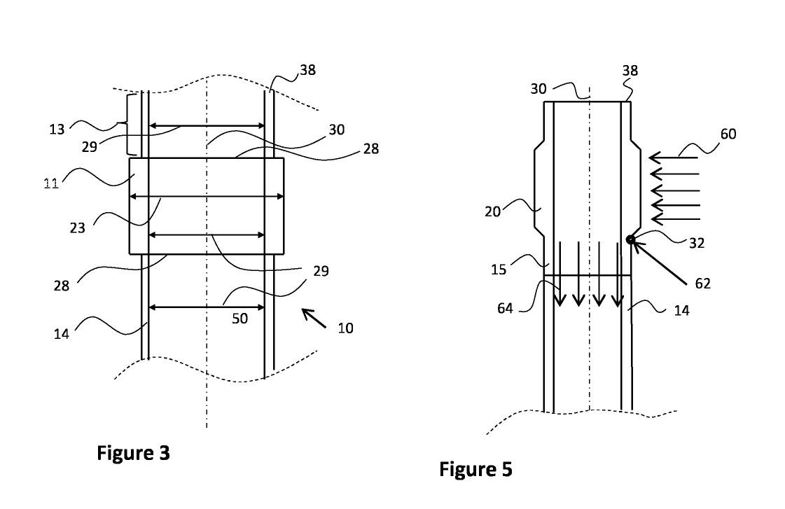

Turning to FIG. 3, in another embodiment the pipe section 10 is formed by connecting three pipes with one another, i.e. a main part 14, a short thicker pipe member 11 and a short normal pipe member 13 forming an end member 13. All three pipes 14, 11, 13 have a same inner diameter 29, but the thicker pipe member 11 has a greater outer diameter 23 than the main part 14 and the end member 13. The thicker pipe member 11 is positioned between the main part 14 and the end member 13. Two welds 28 are provided. In an embodiment, all three pipes are manufactured from line pipe.

Alternatively, the normal short pipe member 13 may be left out, resulting in a pipe section 10 composed of two pipes 14 and 11. The word “normal” in this context indicates that the outer and inner diameter are the same as the outer and inner diameter of the main part 14.

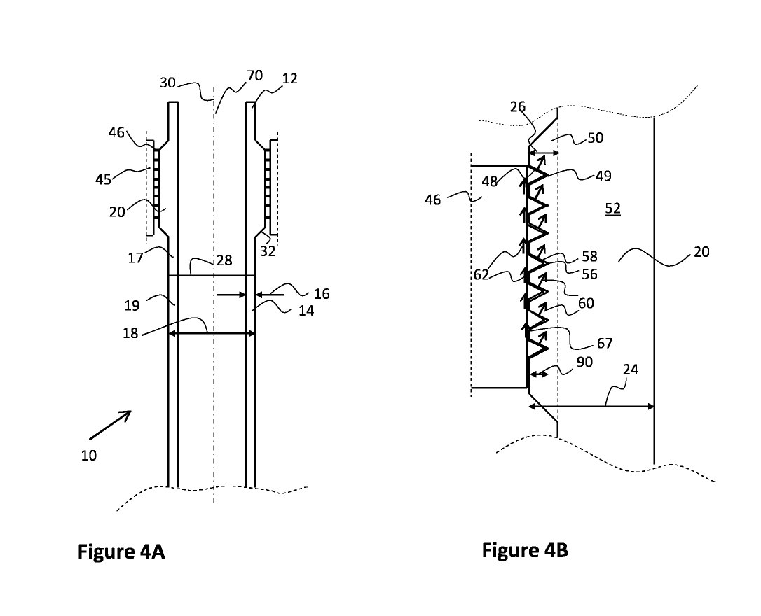

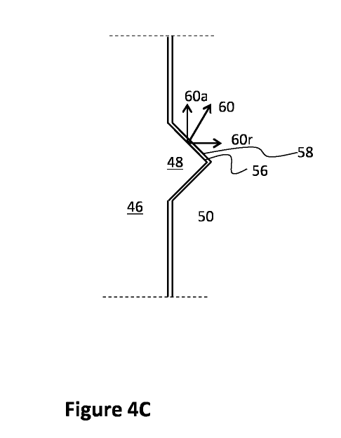

Turning to FIGS. 4A, 4B and 4C, a part of a pipe clamp 45 is shown. Pads 46 having protrusions 48 (or teeth) grip the pipe section 10. The pads 46 are part of the pipe clamp 45. The pads 46 extend parallel to an imaginary firing line 70, which in use corresponds with the pipe axis 30. The pipe clamp 45 may comprise a grid of at least 30 by 70 protrusions, i.e. at least 30 protrusions 48 in an axial direction and at least 70 protrusions in a circumferential direction. The protrusions 48 are pressed into the thickened gripping zone 20 and form indentations 49.

The protrusions 48 protrude over a radial distance 90 from the pads 46. This radial distance 90 may lie between 0.2 and 0.7 times the width 26 of the gripping zone 20.

The radial distance 90 is between 2-10 mm, in particular between 3-7 mm. The protrusions protrude from the surface of the pads over a radial distance 90 of between 0.005 and 0.03 times the total height of the friction pads. The height of the friction pads corresponds substantially to the length 22 of the thickened gripping zone 20.

The radial distance 90 lies between 0.1 and 0.5 times the thickness of the pipe wall 15 of the main part 14 of the pipe section 10.

The protrusions 48 are substantially cone shaped, but may have other forms, such as a triangular shape or a pyramid shape. Other shapes are also possible. The protrusions 48 may be sharp, but may also be blunt, e.g. have a convex surface such as a half dome shape. The protrusions may also have a substantial circumferential length, i.e. when seen in the direction of the firing line 30. The protrusions 48 may extend over a circular sector of for instance 10-90 degrees.

Generally, the clamp 45 will comprise 3-6 pads 46 which together span the full circumference (i.e. 360 degrees) or almost the full circumference of the pipe section, when seen in the direction of the firing line. Small gaps are provided between two adjoining pads 46. If the protrusions 48 extend over a substantial circumferential distance, each protrusion 48 may extend over a maximum circular sector of 120 degrees in the case of three pads, over a maximum circular sector of 90 degrees in the case of four pads, over a maximum circular sector of 72 degrees in the case of five pads and over a maximum circular sector of 60 degrees in the case of six pads. Respective protrusions 48 on the respective pads 46 may together form an annular form or an almost-annular form.

The pipe clamp 45 comprises a hydraulic system for moving the pads 46 between a clamping position and a retracted position, at which the pads 46 are retracted from the firing line 70. In use, the firing line 70 coincides with the pipe axis 30.

The pipe wall at the thickened gripping zone 20 can be subdivided into two virtual layers, i.e. an outer layer 50 which is subject to indentations 49 from the protrusions 48, and an inner layer 52 which is not plastically deformed by the indentations 49 of the protrusions 48. The thickness of the inner layer 52 corresponds to the wall thickness of the main part 14 of the pipe section 10 and is sufficiently thick to warrant the structural integrity of the pipe section 10 and the water tightness of the pipe section 10.

The indentations 49 are lasting deformations, i.e. plastic deformation of the pipe section 10 occurs when they are formed. The upper sides 56 of the protrusions 48 exert respective upwardly directed vertical forces 60 on the upper sides 58 of the indentation 49 in the thickened gripping zone 20. These upward “teeth’ forces 60 form the total upward force exerted on the pipeline by the pipe clamp 46. The upwardly directed forces 60 may be resolved into a purely axial force 60a and a purely radial force 60r, as is shown in FIG. 4C.

The upward forces 60 of the protrusions 48 are converted into shear stresses in the thickened gripping zone 20. Therefore, the clamp 45 can be indicated as a “shear clamp”. The shear stresses from the upward forces 60 are converted and combined into a total axial stress in the pipe wall.

When viewed from above, the total surface area of each upper side 56 may be between 50 and 200 mm2.

Each protrusion 48 can exert an axial force onto the pipe which depends on the size of the protrusion. The total axial force which can be transferred onto the pipe is dependent on the number of protrusions 48 and the size of the protrusions.

The maximum total force that the thickened gripping zone can bear depends on the surface area of the thickened gripping zone 20 and the width 26 of the thickened gripping zone 20. The surface area in turn is determined by the length 22 of the thickened gripping zone and the circumference of the pipe section 10. The maximum axial force that the thickened gripping zone can bear is therefore dependent on the volume of the thickened gripping zone 20, i.e. the length 22 times the circumference times the width 26.

A total required axial force may be transferred by the shear clamp 45 onto the pipe section 10 via a large number of relatively small protrusions 48 or by a smaller number of relatively large protrusions 48. In an analogous way, a gripping zone 20 having a great length 22 and a relatively small width 26 can accommodate a relatively large number of small protrusions 48, whereas a gripping zone 20 having a smaller length 22 and a relatively great width 26 can accommodate a relatively small number of relatively large protrusions 48. The maximum total axial force that these two different gripping zones can bear may be the same.

The thickened gripping zone 20 of the pipe section 10 according to the invention can be a steel tube which is simply welded around a pipe element 25. This is generally not possible or very difficult with a collar for a collar clamp. Generally, these collars are made as integral forging pieces which are quite expensive.

The pipe section 10 is constructed to be held by shear forces/shear stresses which are exerted by the inserted protrusions 48 on the pipe section. The pipe section 10 according to the invention is not constructed to be held by friction forces or by axial forces of a collar clamp. In practice, some friction forces 62 may occur between the vertical surfaces 67 of the pads 46 which extend between the protrusions 48 and the outer surface 21 of the thickened gripping zone. These friction forces 62 may be small in comparison with the shear forces 60 exerted by the protrusions 48. It is also possible that the friction forces 62 are zero or almost zero, i.e. that the entire axial force is exerted onto the pipeline via the protrusions 48.

Turning to FIG. 5, the stresses which occur in the pipe section 10 are three-dimensional by nature. The hoop stress 60, the von Mises stress 62 and the axial stress 64 are shown. The von Mises stress 62 occurs primarily in the lower transition region 32 between the thickened gripping zone 20 and the main part 14 of the pipe section 10. The von Mises criterion is applied to determine whether the material will yield or not. At the thickened gripping zone 20, hoop stresses (whoop) occur by the compressive force of the pipe clamp 45 which acts on the pipe wall 15 in a direction perpendicular to the pipe axis 30. The pipe clamp 45 also exerts an upward force on the pipe section 10. In the pipe wall 15 at a distance from the thickened gripping zone 20, there are substantially no hoop stresses left and there is only an axial stress in the pipe wall 15.

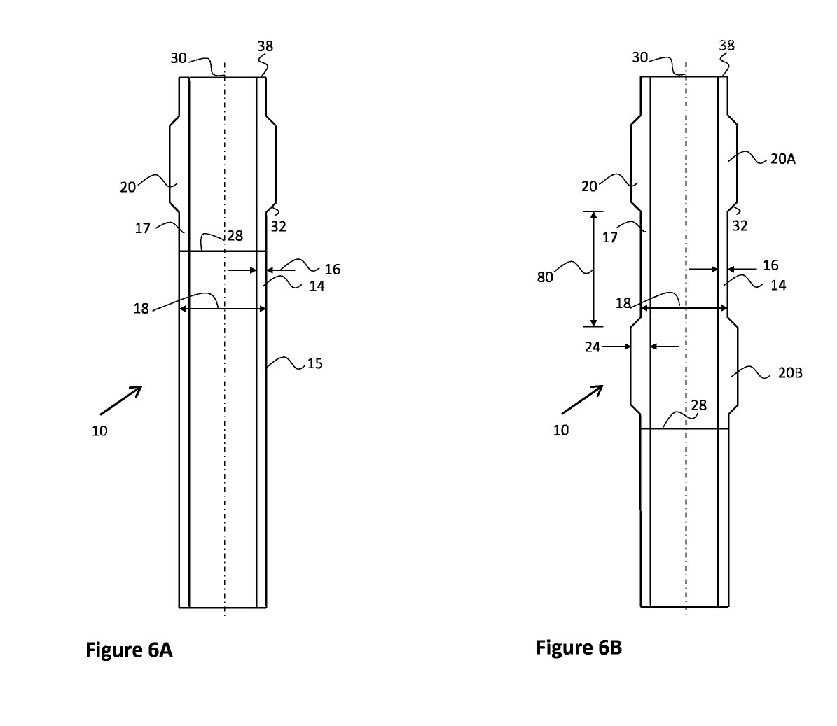

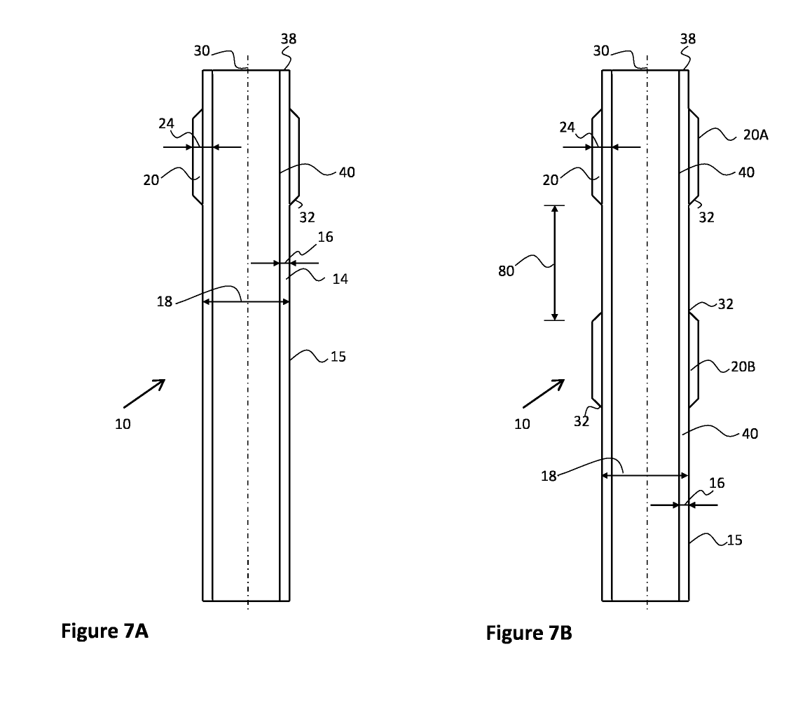

Turning to FIGS. 6A and 7A, the pipe section 10 comprises a single thickened gripping zone 20. This pipe section 10 is constructed to be laid by a pipeline laying vessel having a movable clamp 45 according to the invention and a fixed clamp in the form of a regular friction clamp, i.e. without protrusions 48, as is known from the prior art. In use, the fixed clamp grips the pipeline directly on the wall of the main section 14.

Turning to FIGS. 6B and 7B, the pipe section 10 may comprise a first, upper thickened gripping zone section 20A and a second, lower thickened gripping zone section 20B. The first thickened gripping zone section 20A is constructed to be held by a movable clamp 45A having protrusions 48, and the second thickened gripping zone section 20B is constructed to be held by a fixed clamp 45B which also has protrusions 48. The first and second thickened gripping zone sections are spaced apart by a distance 80. The movable shear clamp 45A is movable along a firing line 70 of the pipeline laying assembly and constructed to pay out the pipeline.

FIGS. 7A and 7B show respective embodiments of a pipe section 10 having one thickened gripping zone section 20 (FIG. 7A) or two thickened gripping zone sections 20A, 20B formed by weld-on tubes 40.

In the embodiment of FIGS. 7A and 7B, the top part 17 comprises both thickened gripping zone sections 20A, 20B.

The embodiment according to FIGS. 6B and 7B may also be manufactured with the method described in FIG. 3, by providing five pipes, i.e.:
a main part,
two short thicker pipe members having a same inner diameter as the main part but a greater outer diameter, and
two normal short pipe members having a same inner diameter and outer diameter as the main part.

The five pipes are arranged in the following sequence: the main part, a short thick pipe member, a normal short pipe member, a short thick pipe member, a normal short pipe member. Alternatively, the last normal short pipe member may be left out, resulting in a pipe section 10 which is composed of four pipes.

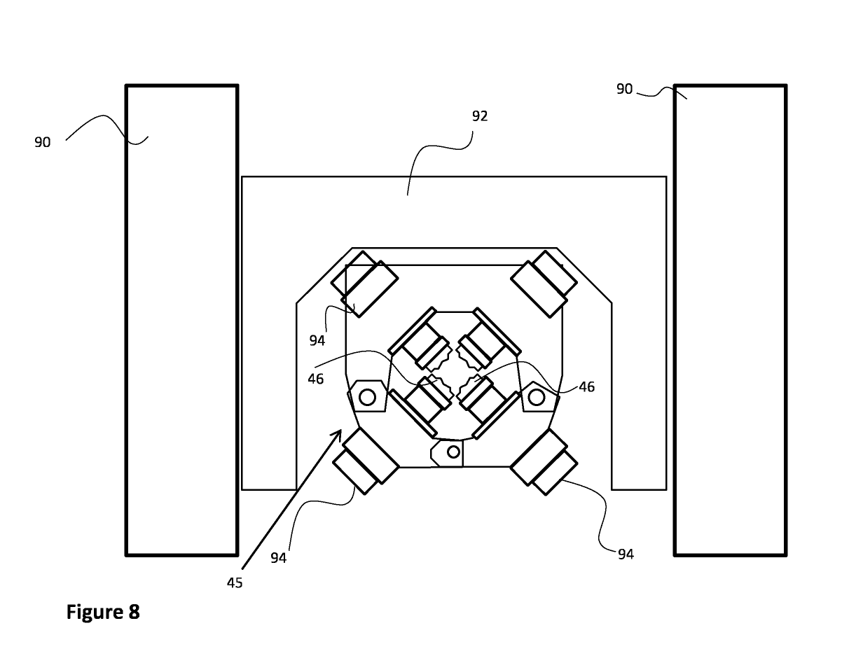

Turning to FIG. 8, the pipe clamp 45 is shown. The pipe clamp 45 may include four hydraulic cylinders 94 each with pads 46 having protrusions 48 for making indentations in the thickened gripping zone(s) 20A (20B) of the pipe section 10. The pipe clamp 45 is supported by a clamp support frame 92, which is secured to a travelling block 105 inside the

J-lay tower 89 on the pipelay vessel 100. During pipelay operations a pipe section 10 is inserted into the clamp 45 and situated between the pads 46. The hydraulic cylinders 94 are then pressurized causing the protrusions 48 on the pads 46 to make indentations on the thickened gripping zone(s) 20.

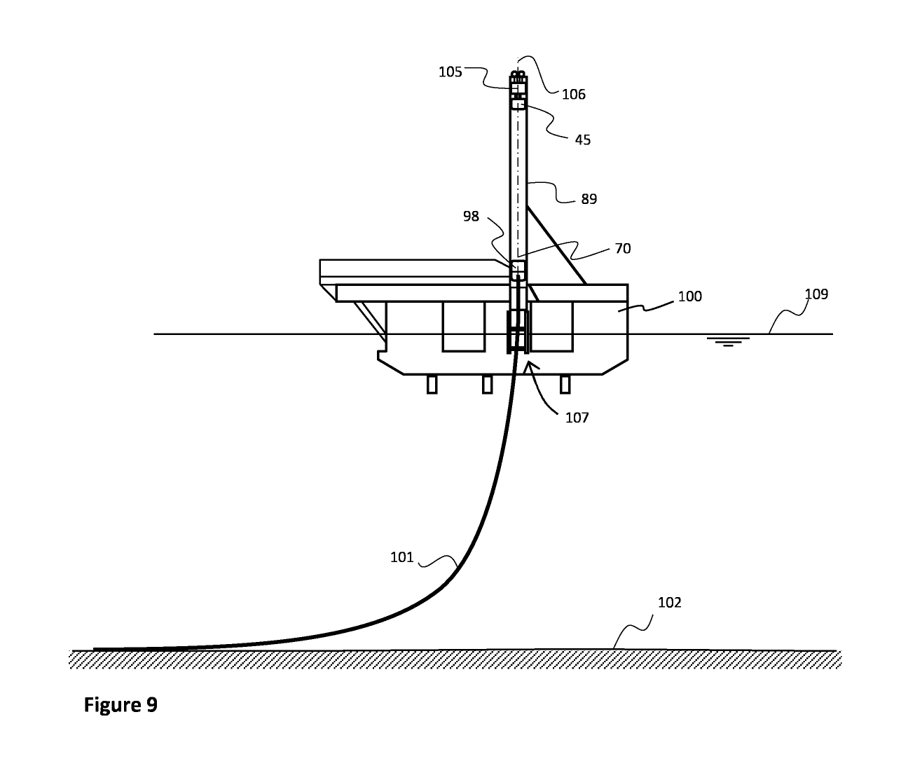

Turning to FIG. 9, a pipelay vessel 100 including a travelling block 105 with clamp 45 is shown. The clamp 45 is movable along the firing line 106 of the J-lay tower 89 which coincides with the pipe axis 30. During pipelay operations the pipe section 10 is welded to the existing pipeline 101 held by a fixed clamp 98. As welding is completed the pipeline is lowered using the movable clamp 45. As successive pipe sections 10 are welded to the growing pipeline 101, it passes through the stinger 107 of the pipelay vessel 100 and onwards towards the seafloor 102 where it is laid.

As discussed above, the fixed clamp 98 may be a regular friction clamp, in which case pipe sections 10 with a single gripping zone 20 are used. The fixed clamp 45 grips the pipe section 10 just below the thickened gripping zone 20. Alternatively, the fixed clamp 45 may be a shear clamp according to the invention. In this embodiment, pipe sections 10 with two gripping zones 20A, 20B are used, one gripping zone 20A for the travelling clamp 45 and one gripping zone 20B for the fixed clamp 98.

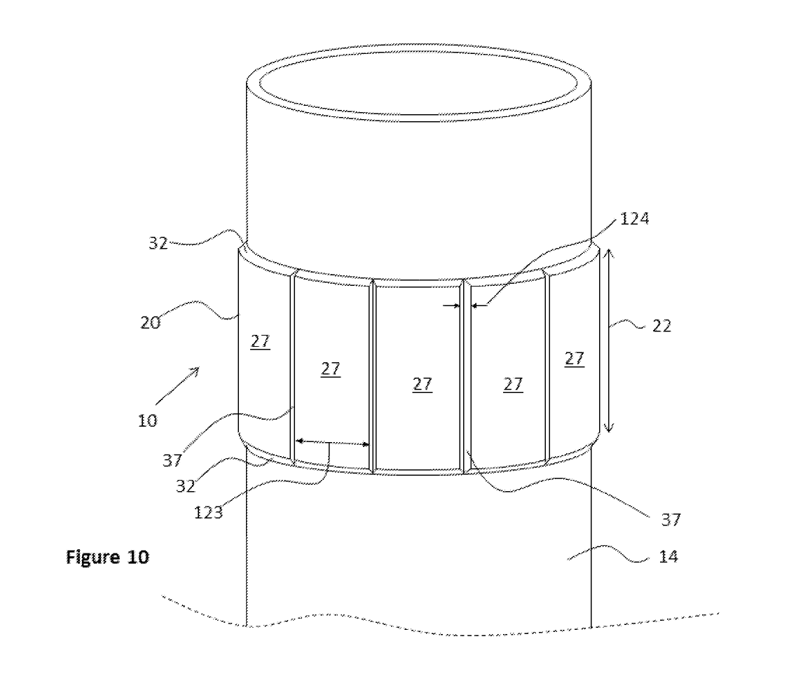

Turning to FIG. 10, another embodiment of the pipe section 10 according to the invention is shown. The thickened gripping zone 20 comprises subzones 27 which are separated by grooves 37 or interspacings 37. The subzones have a width 123 and a length 22. The grooves or interspacings 37 extend in the axial direction and have a width 124. The subzones 27 are distributed about the circumference of the pipe section. The grooves 37 or interspacings 37 are shown as being quite narrow relative to the width 123 of the subzones, but the grooves or interspacings may, in an embodiment, have a width 124 which is substantial compared with the width of the subzones, e.g. one third or half of the width 123 of the subzones 27.

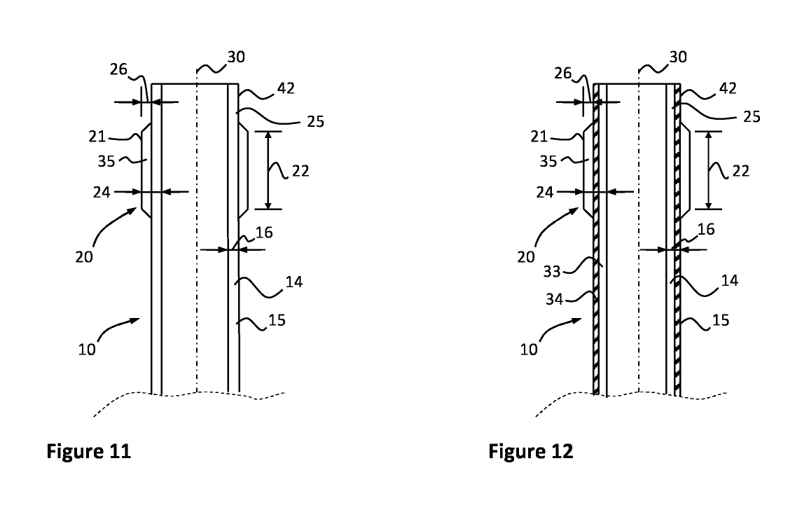

The pipe section 10 of FIG. 11 comprises a pipe element 25 with a uniform wall thickness along its length. The pipe element 25 is made from a metallic material, such as steel. An extra layer 35 of material is attached to an outer surface 42 of the pipe element 25. The extra layer 35 of material is not integral with the pipe element 25. The words “thickened gripping zone 20” refer to the combination of the extra layer 35 of material and the region of the pipe element 25 to which the extra layer 35 of material is attached. The extra layer 35 of material fully surrounds the pipe element 25. In other examples, the extra layer 35 of material surrounds the pipe element 25 partly. The extra layer 35 comprises a non-metallic material. The extra layer 35 comprises a polymer material, such as a polyolefin material. The extra layer 35 can be made of a material used for coating a pipe section, for instance polypropylene.

The pipe element 25 of the pipe section 10 of FIG. 12 differs from the one shown in FIG. 11, in that the pipe element 25 comprises an inner layer 33 made from a metallic material, such as steel, and an outer layer 34 made from a non-metallic material. The outer layer 34 forms a coating on the metallic inner layer 33. The outer layer 34 provides the inner layer 33 with corrosion or mechanical protection or insulation. The extra layer 35 of material is connected to the non-metallic outer layer 34. The extra layer 35 of material can be integral with the pipe element 25. The outer layer 34 comprises a polymer material, such as a polyolefin material. The extra layer 35 comprises a polymer material, such as a polyolefin material. In one example, the extra layer 35 is made from the same material as the outer layer 34. In another example, the extra layer 35 is made from a different material as the outer layer 34.

The method of manufacturing the pipe section of FIG. 11 or 12 comprises the steps of providing the pipe element 25 and attaching the extra layer 35 of material to the outer surface 42 of the pipe element 25.

It will be obvious to a person skilled in the art that the details and the arrangement of the parts may be varied over considerable range without departing from the spirit of the invention and the scope of the claims.

1.-45. (canceled)

46. A pipe section, constructed to be joined end-to-end to a same pipe section in order to form a pipeline which is laid from a pipeline laying vessel, the pipe section having a pipe wall, the pipe section comprising a thickened gripping zone which has a greater wall thickness than the wall thickness of a main part of the pipe section, wherein the thickened gripping zone is constructed and arranged to allow lasting indentations to be made into the thickened gripping zone by a pipe clamp having protrusions which—in use—are pressed into the thickened gripping zone, in order to transfer the axial force required for suspending the pipeline from the pipeline laying vessel to the seabed.

47. The pipe section according to claim 46, wherein the thickened gripping zone is composed of multiple subzones which are arranged about the circumference of the pipe section and which are separated from one another by grooves or interspacings, at which grooves or interspacings the pipe section has a smaller wall thickness than a wall thickness of the gripping zone.

48. The pipe section according to claim 46, wherein the thickened gripping zone is formed by a substantially annular metal tube which is welded to the outer surface of a pipe element and which surrounds the pipe element, and wherein the pipe element is manufactured from steel and the weld-on metal tube is manufactured from a corrosion resistant alloy.

49. The pipe section according to claim 46, wherein the thickened gripping zone comprises an extra layer of material which is attached to the outer surface of a pipe element.

50. The pipe section according to claim 49, wherein the pipe element comprises an inner layer made from a metallic material, such as steel, and an outer layer made from a non-metallic material.

51. A pipe clamp constructed to be mounted on a pipeline laying vessel and configured to grip a pipeline composed of pipe sections according to claim 46 during a pipeline laying operation, the pipe clamp comprising a plurality of protrusions which are constructed to be pressed into the thickened gripping zone of an upper end of the pipeline and to make lasting indentations in the thickened gripping zone when the pipeline is gripped by the pipe clamp and to exert an upward force on the pipeline via the protrusions.

52. The pipe clamp according to claim 51, further comprising pads which are movable between a clamping position and a released position, wherein the protrusions protrude from the pads, wherein the pads have a total height which lies between 0.5 and 2 times a diameter which is enclosed by the pads when the pads are positioned in the clamping position, in particular between 0.8 and 1.5 times the diameter which is enclosed by the pads when the pads are positioned in the clamping position.

53. The pipe clamp according to claim 51, further comprising multiple gripping pads which are spaced apart and which are interrupted by non-gripping areas, the pads corresponding with, and to be used in combination with a pipe section comprising a thickened gripping zone having subzones which are arranged about the circumference of the pipe section and which are separated from one another by grooves or interspacings.

54. A combination of a pipe clamp according to claim 51 and a pipe section according to claim 46.

55. The combination of the pipe clamp and the pipe section of claim 54, wherein the protrusions protrude over a radial distance from a surface of the pads, wherein said radial distance lies between 0.1 and 0.5 times the thickness of the pipe wall of the main part of the pipe section.

56. The combination of the pipe clamp and the pipe section of claim 54, wherein the protrusions protrude over a radial distance from a surface of the pads, wherein said radial distance lies between 0.1 and 0.9 times the wall thickness of the thickened gripping zone.

57. A pipeline laying vessel comprising at least one pipe clamp according to claim 51.

58. A method of laying a pipeline from a pipeline laying vessel, the method comprising:
providing a plurality of pipe sections according to claim 46,
providing a pipeline laying vessel comprising a pipe clamp according to claim 51, and
suspending the pipeline from the pipeline laying vessel to the seabed by pressing the protrusions of the pipe clamp into said thickened gripping zone, making lasting indentations in the thickened gripping zone and transferring an axial force to the pipeline via the protrusions.

59. The method of claim 58, wherein said pipe clamp is a movable clamp, and wherein the pipeline laying vessel comprises a fixed clamp which is a regular friction clamp, the method performing alternating steps of:
lowering the pipeline with the movable clamp by pressing the protrusions into the thickened gripping zone and transferring an axial force to the pipeline, while moving the movable clamp downward, and
holding the pipeline with the fixed regular friction clamp by gripping the pipeline at a different section of the pipeline than the thickened gripping zone with the fixed regular friction clamp.

60. A method of manufacturing a pipe section according to claim 46 which is to be laid with the method according to claim 58, the method comprising the steps of:
a. providing a pipe element without a thickened gripping zone and welding a short pipe having a thickened gripping zone to a distal end of the pipe element, or
b. providing a pipe element without a thickened gripping zone and locally increasing the wall thickness by depositing weld metal onto the outer pipe wall, or
c. providing a pipe element without a thickened gripping zone and welding a metal tube to the outer surface of the pipe element, the metal tube forming the thickened gripping zone, or
d. hitting one end face of a pipe element very hard with a tool, thereby deforming an upper end of the pipe element to such an extent that the pipe section wall of the upper end obtains a greater thickness and becomes the thickened gripping zone by virtue of its greater wall thickness, or
e. providing a pipe element having a wall thickness which corresponds to the intended wall thickness of the thickened gripping zone and removing excessive material of the main section of the pipe element, or
f. providing a metal tube having a slightly smaller inner diameter than the outer diameter of a pipe element, and cooling the pipe element relative to the metal tube or heating the metal tube relative to the pipe section, so that due to thermal expansion the inner diameter of the metal tube becomes slightly greater than the outer diameter of the pipe element, sliding said metal tube over the pipe element into a desired position, cooling the metal tube relative to the pipe element in order to obtain the same temperature as the pipe element so that the metal tube becomes secured to the pipe element and forms the thickened gripping zone.

61. A method of manufacturing a pipe section according to claim 46 which is to be laid with the method according to claim 58, the method comprising the steps of providing a pipe element without a thickened gripping zone and attaching an extra layer of material to the outer surface of the pipe element.

62. The method according to claim 61, wherein the extra layer of material is attached to the pipe element such that the extra layer at least partly surrounds the pipe element.

63. The method according to claim 61, wherein the provided pipe element comprises an inner layer made from a metallic material, such as steel, and an outer layer made from a non-metallic material.

64. A method of manufacturing a pipe section according to claim 46 which is to be laid with the method according to claim 58, the method comprising the steps of connecting at least two pipes with one another, a main part and a short thicker pipe member.

65. The method according to claim 58, further comprising:
a. connecting three pipes with one another, a main part, a short thicker pipe member and short normal pipe member, wherein the short thicker pipe member is arranged between the main part and the short normal pipe member and wherein the short thicker pipe member has a greater outer diameter than the main part and the short normal pipe member, or
b. connecting four pipes with one another in an arrangement having the following sequence, a main part, a short thicker pipe member, a short normal pipe member and another short thicker pipe member, or
c. connecting five pipes with one another in an arrangement having the following sequence, a main part, a short thicker pipe member, a short normal pipe member, another short thicker pipe member and another short normal pipe member.
